(19) United States
(12) Patent Application Publication
(10) Pub. No.: US 2021/0252844 A1
(43) Pub. Date: Aug. 19, 2021

(54) LOW OLIGOMER MODIFIED POLYESTER FILM CAPABLE OF BEING EASILY EXTENDED AND METHOD FOR MANUFACTURING THE SAME

(71) Applicant: NAN YA PLASTICS CORPORATION, TAIPEI (TW)

(72) Inventors: TE-CHAO LIAO, TAIPEI (TW); Wen-Cheng Yang, TAIPEI (TW); CHING-YAO YUAN, TAIPEI (TW); Chia-Yen Hsiao, TAIPEI (TW)

(21) Appl. No.: 17/037,880

(22) Filed: Sep. 30, 2020

(30) Foreign Application Priority Data
Feb. 18, 2020 (TW) 109105139

(51) Int. Cl. B32B 27/36; B32B 27/08; C08K 5/00; B29C 55/14; B29C 55/02

(52) U.S. Cl. CPC B32B 27/36; B32B 27/08; C08K 5/0083; C08K 5/005; B29C 55/143; B32B 2255/26; B32B 2367/00; B32B 2307/51; B32B 2307/518; B32B 2250/02; B32B 2250/24; B29C 55/023

(57) ABSTRACT

A low oligomer modified polyester film capable of being easily extended and a method for manufacturing the same are provided. The modified polyester film includes a base layer and at least one skin layer formed on the base layer, each of which is formed from a polyester composition. The polyester composition includes 1 to 60 wt % of a blend resin, 0.02 to 2 wt % of an antioxidative ingredient, 0.003 to 2 wt % of a nucleation agent, and 0.003 to 2 wt % of a processing and flowing aid. The blend resin includes 90 to 99.9 phr of a polyester resin and 0.01 to 10 phr of an acrylic resin. The polyester resin has an intrinsic viscosity between 0.62 dl/g and 1.00 dl/g, and the acrylic resin has a weight average molecular weight (Mw) between 10,000 and 80,000.

### CROSS-REFERENCE TO RELATED PATENT APPLICATION

This application claims the benefit of priority to Taiwan Patent Application No. 109105139, filed on Feb. 18, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a polyester film, and more particularly to a low oligomer modified polyester film capable of being easily extended and a method for manufacturing the same.

### BACKGROUND OF THE DISCLOSURE

Polyesters, for example, polyethylene terephthalate, polyethylene 2,6-naphthalene dicarboxylate, etc., show exemplary performance in aspects of moldability, mechanical properties, thermal properties, electrical properties, chemical resistance, and so forth. Accordingly, polyesters can be used for different purposes, such as being used as an optical film, an electrical insulating film, a barrier film, a carrier film, a release film, a protective film, an agricultural film, a packaging material, and a heat insulation film.

However, when a polyester film is used in a high temperature environment as part of a device or is processed in a high temperature environment, the polyester film is prone to bleaching and cracking, and has obvious thermal contraction such that a size of the film is unstable. Furthermore, a large amount of oligomer may precipitate on a surface of the film, and the above mentioned conditions may limit the application of the polyester film.

In addition, as the size of semiconductor components becomes smaller and the structure thereof becomes more complex, the processing technology of semiconductor components has developed to 5 nm processes. Therefore, the back-end packaging materials required for active component chips face great challenges.

At present, most advanced packaging materials are monopolized by major European, American and Japanese manufacturers. As a result, the cost for acquiring packaging materials is high, the profit margin is decreased, and the delivery time is longer. In the increasingly competitive packaging industry, the localization of packaging materials is an urgent issue.

In the related art, a conventional silicon chip is encapsulated using an encapsulant after being mounted by wire bonding or flip chip bonding. The material of the encapsulant is a composite material composed of epoxy resin, ceramic powder, carbon black, etc., and is filled between gold wires, copper wires or lead frames to provide insulation. Nowadays, flip chip technology has been introduced into three-dimensional structure, and the required characteristics of packaging materials must be matched with advanced machines and sealants with stable dimensions. In addition, in order to meet the requirements of three-dimensional sealing operations, including the realization of high speed and high stability, the sealing compound is usually first applied to the polyester film as a carrier film, and then three-dimensional packaging of a semiconductor is performed.

### SUMMARY OF THE DISCLOSURE

In response to the above-referenced technical inadequacies, the present disclosure provides a low oligomer modified polyester film capable of being easily extended, and meeting the requirements of semiconductor three-dimensional packaging, including high packaging speed and high stability. In addition, the present disclosure further provides a method for manufacturing the low oligomer modified polyester film capable of being easily extended.

In one aspect, the present disclosure provides a low oligomer modified polyester film capable of being easily extended, which includes a base layer and at least one skin layer formed on the base layer, each of which is formed from a polyester composition. The polyester composition includes 1 to 60 wt % of a blend resin, 0.02 to 2 wt % of an antioxidative ingredient, 0.003 to 2 wt % of a nucleation agent, and 0.003 to 2 wt % of a processing and flowing aid. The blend resin includes 90 to 99.9 phr of a polyester resin and 0.01 to 10 phr of an acrylic resin. The polyester resin has an intrinsic viscosity between 0.62 dl/g and 1.00 dl/g, and the acrylic resin has a weight average molecular weight (Mw) between 10,000 and 80,000.

In another aspect, the present disclosure provides a method for manufacturing a low oligomer modified polyester film capable of being easily extended, which includes forming at least one polyester composition into an unstretched polyester thick film. The polyester composition includes 1 to 60 wt % of a blend resin, 0.02 to 2 wt % of an antioxidative ingredient, 0.003 to 2 wt % of a nucleation agent, and 0.003 to 2 wt % of a processing and flowing aid. The blend resin includes 90 to 99.9 phr of a polyester resin and 0.01 to 10 phr of an acrylic resin. The polyester resin has an intrinsic viscosity between 0.62 dl/g and 1.00 dl/g, and the acrylic resin has a weight average molecular weight (Mw) between 10,000 and 80,000. After that, the unstretched polyester thick film is stretched in a machine direction (MD) and a transverse direction (TD) to form a biaxially stretched polyester film, which includes a base layer and at least one skin layer formed on the base layer, and the stretching in the machine direction (MD) is performed at a stretch ratio of 2 to 5 times, and the stretching in the transverse direction (TD) is performed at a stretch ratio of 2 to 5 times.

One of the advantages of the present disclosure is that the low oligomer modified polyester film capable of being easily extended can provide a proper glass transition temperature, excellent extensibility, stiffness and rigidity, and can also suppress the precipitation of polyester oligomers, by virtue of “the substrate layer and the surface layer being each formed from a polyester composition including specific amounts of a blend resin, an antioxidative ingredient, a nucleation agent, and processing and flowing aid, the blend resin being a mixture of a polyester resin and an acrylic resin in a specific weight ratio, and the polyester resin having an intrinsic viscosity between 0.62 dl/g and 1.00 dl/g, and the acrylic resin having a weight average molecular weight (Mw) between 10,000 and 80,000”.

The method for manufacturing the low oligomer modified polyester film capable of being easily extended of the present disclosure, which heat shrinks the polyester film in the machine and traverse directions under specific stretch conditions after performing a stretch process, allows the polyester film thus produced to have very low heat shrinkage rates of the machine and traverse directions in a high temperature environment, and the haze (ΔHaze) is also less than 1%.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a flowchart of a method for manufacturing a low oligomer modified polyester film capable of being easily extended of the present disclosure.

FIG. 2 is a structural schematic view of the low oligomer modified polyester film capable of being easily extended of the present disclosure.

FIG. 3 is another structural schematic view of the low oligomer modified polyester film capable of being easily extended of the present disclosure.

### DETAILED DESCRIPTION OF THE EXEMPLARY EMBODIMENTS

Polyester films have a wide range of uses. In consideration of mechanical, electrical, and thermal properties, the polyester films can serve as barrier films for batteries (e.g., automotive batteries, fuel cells, and lithium batteries), films for pressing molds, high temperature resistant release films, matte films for hot pressing, and carrier films for semiconductor element packaging. Therefore, the present disclosure provides a technical solution that is capable of improving heat resistance and dimensional stability of the polyester film and can suppress the precipitation of polyester oligomers.

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

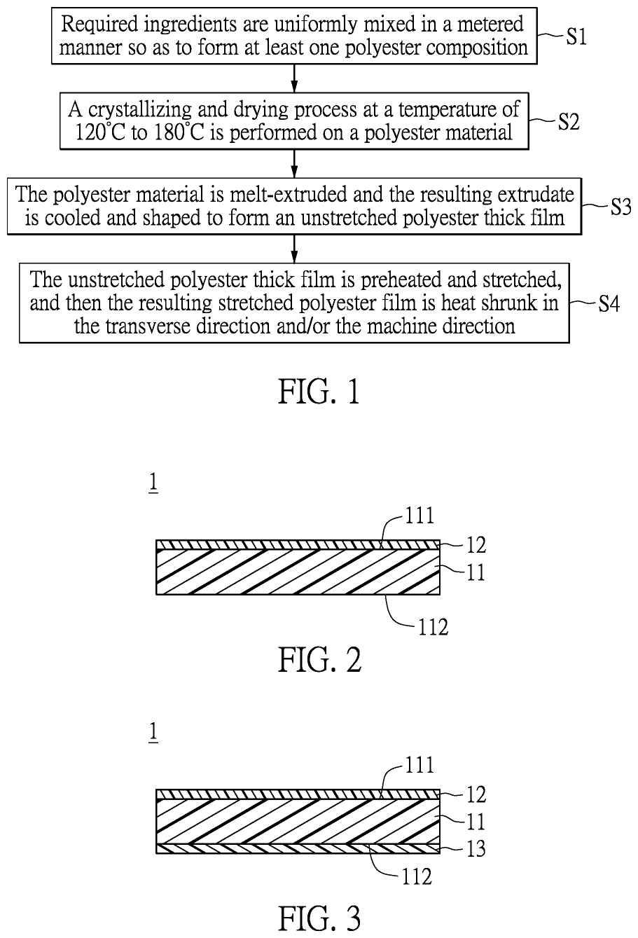

Referring to FIG. 1, a method for manufacturing a low oligomer modified polyester film capable of being easily extended includes the steps as follows. Step S1 is a metering and mixing step, in which required ingredients are uniformly mixed in a metered manner so as to form at least one polyester composition. Step S2 is a crystallizing and drying step, in which a crystallizing and drying process at a temperature of 120° C. to 180° C. is performed on a polyester material. Step S3 is a step for melt extrusion, cooling and molding, in which the polyester material is melt-extruded and the resulting extrudate is cooled and shaped to form an unstretched polyester thick film Step S4 is a stretching and processing step, in which the unstretched polyester thick film is preheated and stretched, and then the resulting stretched polyester film is heat shrunk in the transverse direction and/or the machine direction.

The polyester composition includes 1 to 60 wt % of a blend resin, 0.02 to 2 wt % of an antioxidative ingredient, 0.003 to 2 wt % of a nucleation agent, and 0.003 to 2 wt % of a processing and flowing aid. The blend resin includes 90 to 99.9 phr of a polyester resin and 0.01 to 10 phr of an acrylic resin. It is worth mentioning that the formula of the polyester composition can directly produce the technical effects of increasing extensibility and heat resistance and preventing the precipitation of polyester oligomers.

More specifically, the polyester resin may be formed by one or more diacids or its derivatives and one or more diols or its derivatives. Specific examples of the diacids and its derivatives include terephthalic acid, isophthalic acid, 1,5-naphthalenedicarboxylic acid, 2,6-naphthalenedicarboxylic acid, 1,4-naphthalenedicarboxylic acid, bibenzoic acid, diphenylethane dicarboxylic acid, diphenyl oxane dicarboxylic acid, anthracene-2,6-dicarboxylic acid, 1,3-cyclopentane dicarboxylic acid, 1,3-cyclohexanedicarboxylic acid, 1,4-cyclohexanedicarboxylic acid, malonic acid, dimethylmalonic acid, succinic acid, 3,3-diethyl succinate, glutaric acid, 2,2-dimethylglutaric acid, adipic acid, 2-methyl adipic acid, trimethyl adipic acid, pimelic acid, azelaic acid, sebacic acid, suberic acid and dodecanedioic acid. Specific examples of the diols and its derivatives include ethylene glycol, propylene glycol, hexamethylene glycol, neopentyl glycol, 1,2-cyclohexanedimethanol, 1,4-cyclohexanedimethanol, 1,10-decanediol, 1,3-propanediol, 1,4-butanediol, 1,5-pentanediol, 1,6-hexanediol, 2,2-bis(4-hydroxyphenyl)propane and bis(4-hydroxybenzene).

In certain embodiments, the polyester resin can be selected from polyethylene terephthalate (PET), polytrimethylene terephthalate (PPT), polybutylene terephthalate (PBT), polyethylene naphthalate (PEN), polybutylene naphthalate (PBN), polycyclohexylenedimethylene terephthalate (PCT), polycarbonate (PC) or polyarylate, and preferably PET, PBT or PEN. The polyester resin has an intrinsic viscosity between 0.62 dl/g and 1.00 dl/g. Accordingly, when shaped, the loads on the polyester resin (e.g., loads caused by the surrounding environment and external forces) can be reduced.

Furthermore, the heat generated by a shearing force from processing can be reduced, so as to avoid thermal decomposition of the polyester resin.

Acrylic resin is polymerized by at least one of the following monomers: methyl (meth)acrylate (MMA), ethyl acrylate (EA), propyl (meth)acrylate (PA), n-butyl acrylate (BA), isobutyl (meth)acrylate (IBA), amyl (meth)acrylate, hexyl (meth)acrylate, heptyl (meth)acrylate, octyl (meth)acrylate, 2-ethylhexyl (meth)acrylate (2-HEA), n-octyl (meth)acrylate (OA), isooctyl (meth)acrylate (IOA), nonyl (meth)acrylate (NA), decyl (meth)acrylate, lauryl (meth)acrylate (LA), stearyl (meth)acrylate, methoxyethyl (meth)acrylate (MOEA), n-butyl-methyl acrylate (n-BMA), 2-ethylhexyl acrylate (2-EHA), and ethoxymethyl (meth)acrylate (EOMAA). The role of acrylic resin is mainly to adjust the resin structure, such that the hardened products have an appropriate glass transition temperature and the extensibility, stiffness and rigidity of the polyester film are improved.

Preferably, the acrylic resin has a weight average molecular weight (Mw) between 10,000 and 80,000. If the weight average molecular weight of the acrylic resin is not within the above range, the physical properties of the polyester film may deteriorate. In addition, a melt flow index of the acrylic resin is 1 to 40 g/10 minutes, which is measured according to the ISO 1133 standard at 230° C. and a load of 3.8 kg. If the melt index of the acrylic resin is less than 1 g/10 minutes, it is not conducive to the processability of the polyester film. If the melt index of the acrylic resin exceeds 40 g/10 minutes, the impact resistance of the polyester film will be reduced.

It is worth mentioning that the acrylic resin with specific physical properties (such as weight average molecular weight and melt index) can promote the formation of non-crystalline structure inside the polyester film during the process of mixing and extruding polyester raw materials after melting, or during the stretching process after film formation, and the internal non-crystalline structure helps to increase the stretching ratio. Therefore, the polyester film can have a high degree of non-crystallinity, as well as improved chemical resistance, water-resistance, and transparency.

The antioxidative ingredient includes 0.01% to 1% by weight of a primary antioxidant and 0.01% to 1% by weight of a secondary antioxidant. The primary antioxidant and the secondary antioxidant can produce a synergistic effect so as to provide better antioxidative effect. More specifically, the primary antioxidant can quickly react with peroxy radicals (ROO.) to stop free radical chain reactions. The secondary antioxidant can react with hydroperoxides (ROOH) to convert them into a substance without free radical and reactivity. The primary antioxidant may be selected from phenolic compounds or amine compounds, which are exemplified by commercially available products with trade names of Irganox 1010, Irganox 1425, Irganox 245, Anox 1315, Anox PP18, Anox 20, Lowinox 1790, Lowinox TBM-68, and Naugard 445. The primary antioxidant may be selected from phosphorous compounds or thioester compounds, which are exemplified by commercially available products with trade names of Sandostab P-EPQ, Irgafos 168, and Naugard 412S.

The nucleating agent can increase total crystallinity and improve the heat resistance of the polyester film. Furthermore, the nucleating agent can promote crystal growth, resulting in fine crystals, and reduce the formation of large spherulites, and avoid the embrittlement of film surfaces. The nucleating agent may be a mineral material, a metal oxide, a silicon compound, a metal salt of an organic or inorganic acid, a phosphate ester metal salt, a polyol derivative, a sulfonylimide compound, a glass powder, a metal powder, or any combination thereof. Specific examples of the mineral material include graphite, talc, and kaolin. Specific examples of the metal oxide include zinc oxide, aluminum oxide, and magnesium oxide. Specific examples of the silicon compound include silicon oxide, calcium silicate, and magnesium silicate. Specific examples of the metal salt of an organic or inorganic acid include metal carbonates such as magnesium carbonate, calcium carbonate, sodium carbonate and potassium carbonate, barium sulfate, calcium sulfate, sodium benzoate, and aluminum p-tert-butylbenzoate. The phosphate ester metal salt is exemplified by an aromatic phosphate ester metal salt. The polyol derivative is exemplified by dibenzylidene sorbitol. In consideration of heat resistance, the nucleating agent is preferably an inorganic material.

The processing and flowing aid can effectively reduce mechanical torque on a polyester material during melt-extrusion, and can reduce a molecular chain scission of a polymer. The processing and flowing aid can be pentaerythritol stearate (PETS) or its analogues, which have good thermal stability, low volatility, good mold release, and flow properties at high temperatures, and allow good nucleation effect on a partial crystalline polyester.

The polyester composition can further include 0.02 to 0.5 wt % of lubricant particles, which can not only improve the heat resistance of the polyester film, but also hinder the fluidity of the oligomer, thereby preventing the precipitation of the oligomer on the surface of the film. The particle size of the lubricant particles can be between 0.005 μm and 2 μm, preferably 1.5 μm.

Hereinafter, the implementation details of each step of the method of the present disclosure will be further described.

Step S1 is a metering and mixing step, in which required ingredients are uniformly mixed in a metered manner so as to form at least one polyester composition. Further, the components of polyester composition, which includes polyester components (such as terephthalic acid, ethylene glycol and catalysts), antioxidant components (such as primary antioxidants and secondary antioxidants), crystal nucleating agents and processing and flowing aids, can be melted and mixed at an appropriate temperature according to a specific composition. The polyester component will undergo an esterification reaction during the mixing process, and the melt polyester formed thereby will be cooled and pelletized such that multifunctional polyester pellets are obtained. In certain embodiments, the primary antioxidant, secondary antioxidant, crystal nucleating agent, and processing and flowing aid can respectively be made into single functional polyester pellets separately from the polyester component.

Step S2 is a crystallizing and drying step, in which a crystallizing and drying process at a temperature of 120° C. to 180° C. is performed on a polyester material (i.e., the polyester pellets). Thus, the polyester material has a water content less than 30 ppm. The processing time of the crystallizing and drying process can be from 3 to 8 hours, but it is not limited thereto.

Step S3 is a step for melt extrusion, cooling and molding, in which the polyester material is melt-extruded and the resulting extrudate is cooled and shaped to form an unstretched polyester thick film More specifically, the polyester material can be formed into a melt with fluidity in a single-layered extrusion or multi-layered co-extrusion manner, which can be achieved by a twin screw extruder. After that, the melt is cast into a film to be formed between casting rolls and cooled for solidification. However, these details are provided for exemplary purposes only and are not meant to limit the scope of the present disclosure.

According to practical requirements, the polyester composition can be processed in the form of a polyester slurry to form an unstretched polyester thick film. Furthermore, the raw material of the polyester pellets, which includes polyester components (such as terephthalic acid, ethylene glycol and catalysts), antioxidant components (such as primary antioxidants and secondary antioxidants), crystal nucleating agents, and processing and flowing aids, can be added to an alcohol solvent (such as ethylene glycol), and then allowed to stand for a period of time after being thoroughly stirred such that a polyester slurry is obtained. Then, the polyester slurry is coated on a substrate, and the slurry is dried and solidified at an appropriate temperature to form an unstretched polyester thick film. It is worth mentioning that the polyester component can undergo an esterification reaction during the stirring and standing process, and the primary antioxidant, secondary antioxidant, crystal nucleating agent and processing and flowing aid can be added to the alcohol solvent before or after the reaction. In addition, the polyester component may also undergo the esterification reaction during the curing process.

The step S4 is a stretching and processing step, in which the unstretched polyester thick film is preheated and stretched, and then the resulting stretched polyester film is heat shrunk in the transverse direction and/or the machine direction. In practice, a sequential or simultaneous biaxial stretching process can be used in step S4. It is worth mentioning that under specific stretch conditions, a crystal orientation of the polyester film can be completed, and the polyester film can have a very low thermal shrinkage rate in both the machine direction and the transverse direction under a high temperature environment.

In certain embodiments, the unstretched polyester thick film is stretched in the machine direction (MD) (i.e., “length direction”) at a temperature from 70° C. to 145° C. to form a uniaxially stretched polyester film. The uniaxially stretched polyester film is then stretched in the transverse direction (TD) (i.e., “width direction”) at a temperature from 90° C. to 160° C. to form a biaxially stretched polyester film According to practical requirements, the stretching processes of the machine direction and the traverse direction can be performed in a reverse order. In certain embodiments, the unstretched polyester thick film can be simultaneously stretched in the machine direction and in the transverse direction at a temperature of 70° C. to 145° C. to directly form a biaxially stretched polyester film.

Further, the stretching ratio of the machine direction is 2 times to 5 times, preferably 2.5 times to 4 times; the stretching ratio of the transverse direction is 2 times to 5 times, preferably 2.5 times to 4 times. The stretching ratio of the machine direction and the transverse direction may be the same or different. The stretching process of the polyester film can be realized by a conventional tenter stretching machine, but it is not limited thereto.

It is worth mentioning that, step S4 includes heat shrinking the biaxially stretched polyester film in the transverse direction and/or the machine direction, thereby increasing the crystallinity of the polyester film and improving the shrinkage stress of the polyester film More specifically, in the heat shrinking process, two ends of the polyester film in the width or length direction can be clamped by clamping fixtures, and thus the polyester film can be repeatedly stretched and relaxed. The extent of every stretching action is 500% and the extent of every relaxing action is 10%. The ring chain may have upper and lower rollers guided by guide rails and are respectively guided by the upper and lower guide rails in different areas of the device. Therefore, the thermal shrinkage of the polyester film at high temperatures can be effectively suppressed, that is, the thermal dimensional stability of the polyester film can be improved, without the need for additional heat treatment after the stretching process. However, these details are provided for exemplary purposes only and are not meant to limit the scope of the present disclosure.

Referring to FIG. 2, the polyester film 1 made using the method of the present disclosure (hereinafter referred to as “low oligomer modified polyester film capable of being easily extended 1”) can have a double-layer structure, including a base layer 11 and a first skin layer 12. The base layer 11 has a first surface 111 and a second surface 112 opposite to each other. The first surface 111 is, for instance, the upper surface of the base layer 11, and the second surface 112 is, for instance, the lower surface of the base layer 11. The first skin layer 12 is formed on the first surface 111 of the base layer 11, and the first skin layer 12 is an easily stretchable layer.

Referring to FIG. 3, the low oligomer modified polyester film capable of being easily extended 1 can also have a three-layered structure that includes a base layer 11, a first skin layer 12, and a second skin layer 13. The first skin layer 12 is formed on the first surface 111 of the base layer 11, the second skin layer 13 is formed on the second surface 112 of the base layer 11, and each of the first skin layer 12 and the second skin layer 13 is an easy embossing layer. In an embodiment that is not shown, the low oligomer modified polyester film capable of being easily extended 1 may also be a single-layered structure.

Further, the base layer 11, the first skin layer 12 and the second skin layer 13 each includes 1 to 60 wt % of a blend resin, 0.02 to 2 wt % of an antioxidative ingredient, 0.003 to 2 wt % of a nucleation agent, and 0.003 to 2 wt % of a processing and flowing aid. The blend resin includes 90 to 99.99 phr of a polyester resin and 0.01 to 10 phr of an acrylic resin, the polyester resin has an intrinsic viscosity between 0.62 dl/g and 1.00 dl/g, and the acrylic resin has a specific physical properties. It is worth mentioning that, the acrylic resin has a weight average molecular weight (Mw) between 10,000 and 80,000, and a melt flow index of the acrylic resin is 1 to 40 g/10 minutes, which is measured according to the ISO 1133 standard at 230° C. and a load of 3.8 kg.

In consideration of heat resistance and prevention of oligomer precipitation, the first skin layer 12 and the second skin layer 13 can further include 0.02 to 0.5 wt % of lubricant particles in addition to the above components. The particle size of the lubricant particles can be between 0.005 μm and 2 μm, preferably 1.5 μm.

In certain embodiments, a total thickness of the low oligomer modified polyester film capable of being easily extended 1 is 25 to 200 μm, and a thickness of the first skin layer 12 and the second skin layer 13 accounts for 2% to 30% of the total thickness of low oligomer modified polyester film capable of being easily extended 1. Therefore, the cyclic oligomer is not easily moved to the surface of the film, especially in a high temperature environment.

### Property Evaluation

Polyester films of Examples 1 to 5 and Comparative Examples 1 and 2 are obtained by steps S1 to S4 mentioned above, with processing conditions as shown in Table 1. The polyester films all have an A/B/A structure (three-layered structure) as shown in FIG. 3, in which A represents a surface layer and B represents a substrate layer. The thicknesses of each layer, the intrinsic viscosity of the polyester masterbatches contained in each layer, and the concentration of functional additives are shown in Table 1. The polyester films are tested for key physical properties by the following test methods, and the results are shown in Table 1.

Test of visible light transmittance and haze: A testing device (model name “TC-HIII DPK”, produced by Tokyo Denshoku Co., Ltd., Japan) was used to test the visible light transmittance and haze value of the polyester films of Examples 1 to 5 and Comparative Examples 1 and 2 in accordance with the JIS K7705 standard before and after being heated. Also, a variation in haze (ΔHaze) of each of the polyester films was calculated. In this test, an oven is used for heating at a heating temperature of 200° C. and a heating time of 3 hours.

Test of thermal shrinkage properties: Polyester films of Examples 1 to 5 and Comparative Examples 1 and 2 were each cut into a square shape of 15 cm×15 cm. After being heated in an oven at 210° C. for 3 hours, longitudinal side length and lateral side length of these polyester films are measured, and the variation in each of the longitudinal side length and lateral side length of these polyester films before and after being heated was calculated. The thermal shrinkage rates of the lengths of the polyester films in the machine direction (MD) and the transverse direction (TD) can be obtained by the following ways: dividing each of the measured longitudinal side length variations obtained by the initial length (i.e., 15 cm) and multiplying by 100%, and dividing each of the measured lateral side length variations obtained by the initial length (i.e., 15 cm) and multiplying by 100%.

Tensile test: The polyester films of Experimental Examples 1 to 5 and Comparative Examples 1 and 2 were each cut into a square shape of 25 cm×15 cm, and then placed in a jig. Then a tensile testing machine applies stress on the fixture and stretches at a constant speed (200 mm/min), the deformation of the polyester film is recorded until the polyester film breaks, and calculates the breaking strength of the polyester film (kgf/mm2) and elongation (%). The breaking strength is the stress strength when the polyester film is stretched to break; the elongation is the amount of elongation deformation when the polyester film is stretched to break.

TABLE 1

| | | | | | | | Comparative | Comparative |
|---|---|---|---|---|---|---|---|---|
| Items | | Example 1 | Example 2 | Example 3 | Example 4 | Example 5 | Example 1 | Example 2 |
| Film | Total thickness | 100 | 100 | 100 | 100 | 100 | 100 | 100 |
| | (μm) | | | | | | | |
| | Co-extrusion | A/B/A | A/B/A | A/B/A | A/B/A | A/B/A | A/B/A | A/B/A |
| | structure | | | | | | | |
| | Thickness of each | 1/98/1 | 1/98/1 | 1/98/1 | 1/98/1 | 1/98/1 | 1/98/1 | 1/98/1 |
| | layer (μm) | | | | | | | |
| Ingredients | PET masterbatch | 70 | 60 | 50 | 40 | 40 | 100 | 30 |
| of A layer | PBT masterbatch | 30 | 40 | 50 | 59.5 | 59 | 0 | 70 |
| | Acrylic resin | 0 | 0 | 0 | 0.5 | 1 | 0 | 0 |
| | The average | 600 | 600 | 600 | 600 | 600 | 600 | 600 |
| | particle size 0.1 | | | | | | | |
| | μm | | | | | | | |
| | Silicon dioxide | | | | | | | |
| | (ppm) | | | | | | | |
| | Primary | 120 | 120 | 120 | 120 | 120 | 120 | 120 |
| | antioxidant (ppm) | | | | | | | |
| | Secondary | 60 | 60 | 60 | 60 | 60 | 60 | 60 |
| | antioxidant (ppm) | | | | | | | |
| | Nucleating agent | 50 | 50 | 50 | 50 | 50 | 0 | 0 |
| | (ppm) | | | | | | | |
| | Processing and | 50 | 50 | 50 | 50 | 50 | 50 | 50 |
| | flowing aid (ppm) | | | | | | | |
| Ingredients | Primary | 120 | 120 | 120 | 120 | 120 | 120 | 120 |
| of B layer | antioxidant (ppm) | | | | | | | |
| | Secondary | 60 | 60 | 60 | 60 | 60 | 60 | 60 |
| | antioxidant (ppm) | | | | | | | |
| | Nucleating agent | 50 | 50 | 50 | 50 | 50 | 0 | 0 |
| | (ppm) | | | | | | | |
| | Processing and | 50 | 50 | 50 | 50 | 50 | 50 | 50 |
| | flowing aid (ppm) | | | | | | | |
| Processing | Drying temperature | 120° | 120° | 120° | 120° | 120° | 120° | 120° |
| conditions | of crystallization | C./8 hrs | C./8 hrs | C./8 hrs | C./8 hrs | C./8 hrs | C./8 hrs | C./8 hrs |
| | (° C./hours) | | | | | | | |
| | Temperature of | 260~280 | 260~280 | 260~280 | 260~280 | 260~280 | 260~280 | 260~280 |
| | extruder (° C.) | | | | | | | |
| | Stretching | 80~90 | 80~90 | 80~90 | 80~90 | 80~90 | 80~90 | 80~90 |
| | temperature of | | | | | | | |
| | machine direction | | | | | | | |
| | (° C.) | | | | | | | |
| | Stretch ratio of | 3 | 3 | 3 | 3 | 3 | 3 | 3 |
| | machine direction | | | | | | | |
| | Stretching | 110~250 | 110~250 | 110~250 | 110~250 | 110~250 | 110~250 | 110~250 |
| | temperature of | | | | | | | |
| | traverse direction | | | | | | | |
| | (° C.) | | | | | | | |
| | Stretch ratio | 3.5 | 3.5 | 3.5 | 3.5 | 3.5 | 3.5 | 3.5 |
| | of traverse | | | | | | | |
| | direction | | | | | | | |
| | Pre-shrinkage | <3 | <3 | <3 | <3 | <3 | <3 | <3 |
| | rate of machine | | | | | | | |
| | direction (%) | | | | | | | |
| | Pre-shrinkage | <3 | <3 | <3 | <3 | <3 | <3 | <3 |
| | rate of traverse | | | | | | | |
| | direction (%) | | | | | | | |
| Physical | Elongation at | 100 | 120 | 140 | 165 | 200 | 80 | 120 |
| properties | 100° C. (%) | | | | | | | |
| of the film | Breaking strength at | 10.2 | 11 | 12 | 11.5 | 11.1 | 10.7 | 7.5 |
| | 100° C. | | | | | | | |
| | (Kg/mm²) | | | | | | | |
| | Shrinkage (MD) | 1.2 | 1.3 | 1.2 | 1.2 | 1.2 | 1.0 | 1.5 |
| | Shrinkage (TD) | 1.2 | 1.3 | 1.3 | 1.3 | 1.3 | 1.2 | 1.7 |
| | Haze (%) | 0.5 | 0.6 | 0.7 | 0.75 | 0.8 | 0.5 | 5.5 |
| | Film haze after | 0.6 | 0.65 | 0.75 | 0.82 | 0.87 | 3.2 | 10.5 |
| | being heated at | | | | | | | |
| | 200° C. for | | | | | | | |
| | 3 hours (%) | | | | | | | |
| | ΔHaze (%) | 0.1 | 0.05 | 0.05 | 0.07 | 0.07 | 2.7 | 5 |

### Advantages of the Embodiments

One of the advantages of the present disclosure is that the low oligomer modified polyester film capable of being easily extended can provide a proper glass transition temperature, excellent extensibility, stiffness and rigidity, and can also suppress the precipitation of polyester oligomers, by virtue of “the substrate layer and the surface layer being each formed from a polyester composition including specific amounts of a blend resin, an antioxidative ingredient, a nucleation agent, and processing, and flowing aid, the blend resin being a mixture of a polyester resin and an acrylic resin in a specific weight ratio, and the polyester resin having an intrinsic viscosity between 0.62 dl/g and 1.00 dl/g, and the acrylic resin having a weight average molecular weight (Mw) between 10,000 and 80,000”.

Further, in the presence of acrylic resin with specific physical properties (such as weight average molecular weight and melt index), the polyester film can have a high degree of non-crystallinity, as well as obtain improved chemical resistance, water resistance and transparency.

The method for manufacturing the low oligomer modified polyester film capable of being easily extended of the present disclosure, which heat shrinks the polyester film in the machine and traverse directions under specific stretch conditions after performing a stretch process, allows the polyester film thus produced to have very low heat shrinkage rates of the machine and traverse directions in a high temperature environment, and the haze (ΔHaze) is also less than 1%.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A low oligomer modified polyester film capable of being easily extended, comprising:
a base layer; and
at least one skin layer formed on the base layer;
wherein the base layer and the at least one skin layer are each formed of a polyester composition, and the polyester composition includes:
1 to 60 wt % of a blend resin including 90 to 99.9 phr of a polyester resin and 0.01 to 10 phr of an acrylic resin, wherein the polyester resin has an intrinsic viscosity between 0.62 dl/g and 1.00 dl/g, and the acrylic resin has a weight average molecular weight between 10,000 and 80,000;
0.02 to 2 wt % of an antioxidative ingredient;
0.003 to 2 wt % of a nucleation agent; and
0.003 to 2 wt % of a processing and flowing aid.

2. The low oligomer modified polyester film according to claim 1, wherein the polyester resin is selected from at least one of polyethylene terephthalate, polybutylene terephthalate and polyethylene naphthalate, and the acrylic resin is polymerized by at least one of the following monomers: methyl (meth)acrylate, ethyl acrylate, propyl (meth)acrylate, n-butyl acrylate, isobutyl (meth)acrylate, amyl (meth)acrylate, hexyl (meth)acrylate, heptyl (meth)acrylate, octyl (meth)acrylate, 2-ethylhexyl (meth)acrylate, n-octyl (meth)acrylate, isooctyl (meth)acrylate, nonyl (meth)acrylate, decyl (meth)acrylate, lauryl (meth)acrylate, stearyl (meth)acrylate, methoxyethyl (meth)acrylate, n-butyl-methyl acrylate, 2-ethylhexyl acrylate, and ethoxymethyl (meth)acrylate.

3. The low oligomer modified polyester film according to claim 1, wherein a melt flow index of the acrylic resin is 1 to 40 g/10 minutes, which is measured according to the ISO 1133 standard at 230° C. and a load of 3.8 kg.

4. The low oligomer modified polyester film according to claim 1, wherein the antioxidative ingredient includes 0.01% to 1% by weight of a primary antioxidant and 0.01% to 1% by weight of a secondary antioxidant.

5. The low oligomer modified polyester film according to claim 1, wherein a total thickness of the low oligomer modified polyester film is 25 to 200 μm, and a thickness of the at least one skin layer accounts for 2% to 30% of the total thickness of the low oligomer modified polyester film, wherein the low oligomer modified polyester film has machine direction (MD) and transverse direction (TD) shrinkage rates of less than 1% after being heated at 200° C. for 3 hours.

6. A method for manufacturing a low oligomer modified polyester film capable of being easily extended, comprising:
forming at least one polyester composition into an unstretched polyester thick film, wherein the polyester composition includes:
1 to 60 wt % of a blend resin including 90 to 99.9 phr of a polyester resin and 0.01 to 10 phr of an acrylic resin, wherein the polyester resin has an intrinsic viscosity between 0.62 dl/g and 1.00 dl/g, and the acrylic resin has a weight average molecular weight between 10,000 and 80,000;
0.02 to 2 wt % of an antioxidative ingredient;
0.003 to 2 wt % of a nucleation agent; and
0.003 to 2 wt % of a processing and flowing aid; and
stretching the unstretched polyester thick film in a machine direction (MD) and a transverse direction (TD) to form a biaxially stretched polyester film, which includes a base layer and at least one skin layer forming on the base layer, wherein the stretching in the machine direction (MD) is performed at a stretch ratio of 2 to 5 times, and the stretching in the transverse direction (TD) is performed at a stretch ratio of 2 to 5 times.

7. The method according to claim 6, wherein the stretching in the machine direction (MD) and the transverse direction (TD) are performed in sequence, the stretching in the machine direction (MD) is performed at a temperature from 70° C. to 145° C., and the stretching in the transverse direction (TD) is performed at a temperature from 90° C. to 160° C.

8. The method according to claim 6, wherein the unstretched polyester thick film is simultaneously stretched in the machine direction (MD) and the transverse direction (TD) at a temperature from 70° C. to 145° C.

9. The method according to claim 6, further comprising: heat shrinking the biaxially stretched polyester film in the machine direction (MD) and/or the transverse direction (TD).

10. The method according to claim 6, further comprising: before forming the unstretched polyester thick film, performing a crystallizing and drying process on the at least one polyester composition at a temperature from 120° C. to 180° C.

11. The method according to claim 10, wherein a duration of the crystallizing and drying process is 3 to 8 hours.

12. The method according to claim 6, wherein the polyester resin is selected from at least one of polyethylene terephthalate, polybutylene terephthalate and polyethylene naphthalate, and the acrylic resin is polymerized by at least one of the following monomers: methyl (meth)acrylate, ethyl acrylate, propyl (meth)acrylate, n-butyl acrylate, isobutyl (meth)acrylate, amyl (meth)acrylate, hexyl (meth)acrylate, heptyl (meth)acrylate, octyl (meth)acrylate, 2-ethylhexyl (meth)acrylate, n-octyl (meth)acrylate, isooctyl (meth)acrylate, nonyl (meth)acrylate, decyl (meth)acrylate, lauryl (meth)acrylate, stearyl (meth)acrylate, methoxyethyl (meth)acrylate, n-butyl-methyl acrylate, 2-ethylhexyl acrylate, and ethoxymethyl (meth)acrylate.

13. The method according to claim 6, wherein a melt flow index of the acrylic resin is 1 to 40 g/10 minutes, which is measured according to the ISO 1133 standard at 230° C. and a load of 3.8 kg.

14. The method according to claim 6, wherein the antioxidative ingredient includes 0.01% to 1% by weight of a primary antioxidant and 0.01% to 1% by weight of a secondary antioxidant.
